(19) United States
(12) Patent Application Publication
(10) Pub. No.: US 2025/0341243 A1
(43) Pub. Date: Nov. 6, 2025

(54) A self-resetting shear-resistant device with low prestressing requirements and force transmission through a unidirectional clamp

(71) Applicant: TONGJI UNIVERSITY, Shanghai (CN)

(72) Inventors: Ying ZHOU, Shanghai (CN); Yi XIAO, Shanghai (CN); Honghao BAI, Shanghai (CN)

(73) Assignee: TONGJI UNIVERSITY, Shanghai (CN)

(21) Appl. No.: 18/873,384

(22) PCT Filed: Mar. 13, 2024
(86) PCT No.: PCT/CN2024/081540

§ 371 Date: Jul. 14, 2025

(30) Foreign Application Priority Data
Sep. 20, 2023 (CN) 202311221351.0

(51) Int. Cl. F16F 13/00; E04B 1/98

(52) U.S. Cl. CPC F16F 13/005; E04B 1/98; F16F 2228/08

(57) ABSTRACT

The present invention proposes a self-resetting shear-resistant device with low prestressing requirements and force transmission through a unidirectional clamp, comprising: a replaceable energy dissipation system, a self-resetting prestressing system, and a support and transmission mechanism for installing the energy dissipation system and the self-resetting prestressing system, wherein the energy dissipation system, the self-resetting prestressing system and the support and transmission mechanism form an integrated body, which is connected to an outside to import energy through the support and transmission mechanism; wherein when the present device undergoes shear deformations, the energy dissipation system therein is subjected to tensile yield deformations, and at the same time, the self-resetting prestressing system is subjected to tensile elastic deformations, with resetting completed by restoring forces produced by deformations of the self-resetting prestressing system in a process of loading.

### TECHNICAL FIELD

The present invention relates to seismic design of new buildings and seismic strengthening of existing buildings.

### BACKGROUND TECHNOLOGY

Energy dissipation shear-resistant devices can currently be applied in many scenarios, such as installation between shear wall-columns, between different spans of frames, and at inflection points in a mid-span of coupling beams. This type of device yields before a main structure based on ductility requirements of a seismic design, concentrating deformation and energy dissipation in this type of device at the same time and playing a role of protecting the main structure.

According to different energy dissipation principles, there are currently many energy dissipation shear-resistant devices, such as viscoelastic type, mild steel type, friction type, lead-rubber type, mild steel-viscoelastic composite type, lead-rubber type, etc. These traditional energy dissipation shear-resistant devices have a high energy dissipation capacity, but large post-earthquake residual displacements result in a slow recovery of the structure's post-earthquake functionality. The self-resetting energy dissipation shear-resistant device has both high energy dissipation capacity and the ability to automatically restore the structure to its normal state, solving a problem of large post-earthquake residual displacement for the traditional energy dissipation anti-shear device.

Established researches on self-resetting energy dissipation shear-resistant devices are still relatively scarce. The known self-resetting energy dissipation shear-resistant devices all require high prestressing to overcome frictions of their own energy dissipation systems resisting resetting to achieve self-resetting of the present device. However, a need to apply a high level of prestressing increases the difficulty of construction, and there are problems such as loss of prestressing under long-term action.

### SUMMARY OF THE INVENTION

For a lack of and deficiencies of existing self-resetting energy dissipation devices, the present invention proposes a self-resetting shear-resistant device with low prestressing requirements and force transmission through a unidirectional clamp, which can achieve a goal of completely resetting the present device by applying a small amount of prestressing through relative sliding of a high-strength steel rod and a self-locking clamp during a device resetting process, thereby eliminating frictional resistance of the energy dissipation system against resetting. This new device can provide both energy dissipation and self-reset capabilities when shear deformation occurs; and only a small amount of prestressing needs to be applied to achieve complete reset of the present device. The present device has characteristics of strong deformation capacity, low cost, reliable performance, and easy replacement of energy dissipation components after an earthquake.

In order to achieve the above objectives, the present invention provides following technical solutions:

A self-resetting shear-resistant device with low prestressing requirements and force transmission through a unidirectional clamp, comprises: a replaceable energy dissipation system, a self-resetting prestressing system, and a support and transmission mechanism for installing the energy dissipation system and the self-resetting prestressing system, wherein the energy dissipation system, the self-resetting prestressing system and the support and transmission mechanism are integrally formed and connected to import energy through the support and transmission mechanism; wherein when undergoing shear deformations, the energy dissipation system in the self-resetting shear-resistant device is subjected to tensile yield deformations (loading), and meanwhile, a prestressing screw in the self-resetting prestressing system is subjected to tensile elastic deformations and a disc spring assembly is subjected to compressive elastic deformations, with resetting completed by restoring forces produced by deformations of the self-resetting prestressing system during shear deformations (loading).

The support and transmission mechanism comprises an upper end connecting component 1, an intermediate connecting component 9, and a lower end connecting component 4, forming a support for installing the self-resetting prestressing system and the energy dissipation system; two end surfaces of the upper end connecting component 1 and the lower end connecting component 4 determine an initial length L of a shear energy dissipation device before separation in a longitudinal direction;

further comprising a left end connecting component 2 and a right end connecting component 3, which form a movable nested structure; the movable nested structure is located between the upper end connecting component 1 and the intermediate connecting component 9, and extends through a wing portion for inputting external shear dislocations and importing energy;
a movable shaft body of the movable nested structure is arranged in a cavity of the upper end connecting component 1 with two wings extending from a side wall of the cavity, upper ends and lower ends of the movable shaft body are in rigid contact with the upper end connecting component 1 and the lower end connecting component 4 respectively, and the movable nested structure slides against each other in an axial direction after inputting the shear dislocations to push the upper end connecting component 1 and the lower end connecting component 4 to be separated.

Specifically, a main body of the upper end connecting component 1 comprises a hollow cylinder, which is divided into two open cavities by an intermediate plate 1-4, with a top opening of the upper cavity 1-2 fixed with a top connecting plate 1-1, and a bottom opening of the lower cavity 1-3 symmetrically grooved on side walls along a center axis of the cavity;
the lower end connecting component 4 comprises a cylindrical rod member 4-1, and a bottom connecting plate 4-2 fixed to a bottom of the cylindrical rod member 4-1;
the intermediate connecting component 9 is provided with an opening in a center for the lower cavity 1-3 of the upper end connecting component 1 to pass through; the movable nested structure comprises the left end connecting component 2, the right end connecting component 3, with the right end connecting component 3 being inserted into the left end connecting component 2;
the left end connecting component 2 comprises a first cylinder 2-1 with slotted side walls and a first wing 2-2, the first wing 2-2 being fixed to an outer wall of the first cylinder 2-1, the first cylinder 2-1 being provided with slots in the side walls;
the right end connecting component 3 comprises a second cylinder 3-1 and a second wing 3-2, the second wing 3-2 being fixed to an outer wall of the second cylinder 3-1; the first cylinder 2-1 and second cylinder 3-1 are of a same height;
the second cylinder 3-1 is placed inside the first cylinder 2-1 to form the movable shaft body of the movable nested structure, and the second wing 3-2 extends out from a groove in the side wall of the first cylinder 2-1 to form a pair of wings of the movable nested structure with the first wing 2-2 on the other side of the movable shaft body, the second wing 3-2 protrudes from the slotted side walls of the first cylinder 2-1 to form a pair of wings of the movable nested structure together with the first wing 2-2 on an other side of the movable shaft body;
conversely, the left end connecting component and right end connecting component are interchangeable in position.

In an axial direction, in a lengthwise direction, the movable nested structure is placed in the lower cavity 1-3 of the upper end connecting component 1, with the first wing 2-2 and the second wing 3-2 protruding from the slots on each side of the lower cavity 1-3 for connecting to an outside, respectively; a top of the movable shaft body of the movable nested structure is in rigid contact with the intermediate plate 1-4 of the upper end connecting component 1, and the bottom of the movable shaft body is placed on the top of and in rigid contact with the cylindrical rod member 4-1 of the lower end connecting component 4; the movable shaft, a cylindrical rod member 4-1 is stacked up and down and inserted and confined within the lower cavity 1-3; under a condition of external energy input, the movable nested structures slide axially against each other for relative displacement of the upper end connecting component 1 and the lower end connecting component 4.

Further, a width W_{2,2} of the first wing 2-2 is required to be less than a slotted width W₁ of the lower cavity 1-3 of the upper end connecting component 1, the width W₃ of the second wing 3-2 is required to be less than both the slotted width W_{2,1} of the first cylinder 2-1 of the left end connecting component 2 and the slotted width W₁ of the lower cavity 1-3 of the upper end connecting component 1 to ensure that the left end connecting component 2 and the right end connecting component 3 can be staggered with each other inside the lower cavity 1-3.

Further, a sum of a height H₄ of the cylindrical rod member (4-1) and a height H₂ of the movable shaft body is required to be slightly greater than a height H₁ of the lower cavity (1-3) of the upper end connecting component, and twice the height H₂ of the movable shaft body is required to be less than the height H₁ of the lower cavity (1-3), satisfying the following relationship: H₄+H₂≥H₁>2H₂.

The energy dissipation system comprises more than two energy dissipation steel rods 8;
upper and lower ends of the energy dissipation steel rods 8 are fixed to the top connecting plate 1-1 of the upper end connecting component 1, and the intermediate connecting component 9, respectively.

Specifically, the energy dissipation steel rods 8 are divided into three segments, the middle portion being a core energy dissipation segment 8-1, and the upper and lower portions being connecting segments 8-2, with the core energy dissipation segment 8-1 yielding and dissipating energy in tension, and the connecting segments 8-2 having a larger diameter to ensure that they do not yield during a loading process.

The self-resetting prestressing system comprises a prestressing system and a self-resetting system:
wherein the prestressing system comprises a prestressing screw 5, a disc spring baffle 6 and a disc spring assembly 7, the disc spring baffle 6 being provided at the top of the disc spring assembly 7; the disc spring assembly 7 comprises a plurality of disc springs connected in parallel, the disc spring assembly 7 and disc spring baffle 6 being set together in the upper cavity 1-2 of the upper end connecting component 1; the top connecting plate 1-1 of the upper end connecting component 1, the second cylinder 3-1 of the right end connecting component 3, the cylindrical rod member 4-1 of the lower end connecting component 4 and the bottom connecting plate 4-2 of the lower connecting component 4 are provided with through-holes in the center; the upper end of the prestressing screw 5 is fixed to the disc spring baffle 6, passes through the disc spring assembly 7 and the through-holes of each connecting component in sequence, and is then fixed to the bottom connecting plate 4-2;
wherein the self-resetting system comprises a self-locking clamp 10 and a high-strength steel rod 11; the self-locking clamp 10 is fixed to the intermediate connecting component 9, and the high-strength steel rod 11 is set between the intermediate connecting component 9 and the lower end connecting component 4; the upper end of the high-strength steel rod 11 is connected to the self-locking clamp 10 and the lower end of the high-strength steel rod 11 is fixed to the bottom connecting plate 4-2 of the lower end connecting component 4, forming a unidirectional force transmitting element.

Specifically, the self-locking clamp 10 in the self-resetting system comprises an anchor ring 10-1, clamping pieces 10-2, an O-shaped rubber ring 10-3, a resetting spring 10-4, and a gland assembly 10-5, wherein:
the clamping pieces 10-2 are multiple pieces, built into the anchor ring 10-1, enclosing an outer part of the high-strength steel rod 11, with a groove reserved at ends of the clamping pieces and provided with the O-shaped rubber ring 10-3, so to enable the clamping pieces to work stably in a gap cavity between the anchor ring 10-1 and the high-strength steel rod 11;
the resetting spring 10-4 is provided in an upper part of the clamping pieces 10-2, and the high-strength steel rod 11 passes through the resetting spring 10-4;
the gland assembly 10-5 is set on the upper part of the anchor ring 10-1 to hold against the resetting spring 10-4, in order for axial stabilization in operation;
the self-locking clamp 10 supports a force in tension by means of occlusion between a plurality of clamping pieces 10-2 and the high-strength steel rod 11, while in compression the clamping pieces 10-2 and the high-strength steel rod 11 are loosened from each other, generating a relative sliding with the high-strength steel rod 11 without bearing force.

Further, positions of the left end connecting component 2 and the right end connecting component 3 in the support and transmission mechanism are interchangeable.

Further, in the self-resetting prestressing system, the prestressing screw 5 is secured by bolts to the disc spring baffle 6 and to the bottom connecting plate 4-2 of the lower end connecting component 4; the self-locking clamp 10 may be secured by welding on top of the intermediate connecting component 9; and the high-strength steel rod 11 may be secured by nuts to the bottom connecting plate 4-2 of the lower end connecting component 4.

Further, in the energy dissipation system, the connecting segments 8-2 of the energy dissipation steel rods 8 are engraved with threads, and top and bottom ends of the energy-consuming steel rod 8 can be fixed to the top connecting plate 1-1 of the upper end connecting component, and to the intermediate connecting component 9 respectively by nuts.

A mechanism of operation of the self-resetting shear-resistant device with low prestressing requirements and force transmission through a unidirectional clamp is as follows:
1) In an initial stationary state, the top of the movable shaft body of the movable nested structure comprising the left end connecting component 2 and the right end connecting component 3 is pressed against the intermediate plate 1-4 of the upper end connecting component 1; the energy dissipation steel rods 8 being stationary on the present device;
2) When an earthquake disaster occurs and external force is input from a certain direction, when the shear deformations is required, the left end connecting component 2 and the right end connecting component 3 of the present device are misaligned with each other by the external force, pushing the upper end connecting component 1 and the lower end connecting component 4 to undergo an axial relative displacement. In this case:
the disc spring assembly 7 in the prestressing system is continuously compressed and stores energy in the upper cavity 1-2;
the high-strength steel rod 11 in the self-resetting system synchronously occludes with the self-locking clamp 10 to perform a self-locking function;
the energy dissipation steel rods 8 outside the upper cavity 1-2 are synchronized to enter an energy dissipation mechanism, which elongates and deforms the energy dissipation materials one by one, and consumes energy by tensile yielding;
3) In a critical state, when the external energy, the external force, stops being input, or when energy stored in the disc spring assembly 7 is greater than the external force, the misalignment displacements of the left end connecting component 2 and right end connecting component 3 show a tendency to decrease. In this case:
the prestressing system consisting of the prestressing screw 5 and the disc spring assembly 7 in series will undergo a reset action due to compression;
along with a resetting process of the prestressing system, the high-strength steel rod 11 and the self-locking clamp 10 in the self-resetting system play an unlocking function and slide relatively, and the high-strength steel rod 11 extends out of the self-locking clamp 10.

The beneficial effects of the present invention are as follows:
(1) Widely used engineering components realize the low prestressing characteristics of the self-resetting device with low cost, stable and reliable performance, and no need for component finishing;
(2) A problem of self-resetting energy dissipation device requiring high level of prestressing and limited deformation capacity is solved;
(3) Only a small amount of prestressing is required to achieve complete self-resetting of the present device;
(4) Energy dissipation components of the present device are arranged on a periphery and can be replaced without disassembling the entire device after an earthquake, allowing the present device to be repaired quickly.

### BRIEF DESCRIPTION OF THE DRAWINGS

FIG. 1 is a structural diagram of a self-resetting shear-resistant device with low prestressing requirements and force transmission through a unidirectional clamp of the present invention;

FIG. 2 is a cross-sectional diagram of the self-resetting shear-resistant device with low prestressing requirements and force transmission through a unidirectional clamp of the present invention;

FIG. 3 is a structural diagram of connecting components of a support and transmission mechanism;

FIG. 4 is a cross-sectional diagram of the connecting components of the support and transmission mechanism;

FIG. 5 is a structural diagram of an upper end connecting component;

FIG. 6 is a cross-sectional diagram of the upper end connecting component;

FIG. 7 is a structural diagram of a left end connecting component and a right end connecting component;

FIG. 8 is a structural diagram of a lower end connecting component;

FIG. 9 is a schematic diagram of a disc spring assembly connecting a disc spring baffle;

FIG. 10 is a schematic diagram of energy dissipation steel rods;

FIG. 11 is a schematic diagram illustrating a structure and a state of a self-locking clamp according to an embodiment of the present invention;

FIG. 12 is a schematic diagram of a structure of the self-resetting shear-resistant device with low prestressing requirements and force transmission through a unidirectional clamp of the present invention;

FIG. 13 is a schematic diagram of an application scenario of the present device according to an embodiment of the present invention;

FIG. 14 is a deformation and energy dissipation mechanism of the present device according to an embodiment of the present invention;

The markups in the drawings are indicated as follows:

1 upper end connecting component, 1-1 top connecting plate, 1-2 upper cavity, lower cavity, 1-4 intermediate plate;

2 left end connecting component, 2-1 first cylinder, 2-2 first wing;

3 right end connecting component, 3-1 second cylinder, 3-2 second wing;

4 lower end connecting component, 4-1 cylindrical rod member, 4-2 bottom connecting plate;

5 prestressing screw, 6 disc spring baffle, 7 disc spring assembly,

8 energy dissipation steel rod, 8-1 core energy dissipation segment, 8-2 connecting segment;

9 intermediate connecting component;

10 self-locking clamp, 10-1 anchor ring, 10-2 clamping piece, 10-3 O-shaped rubber ring, 10-4 resetting spring;

10-5 gland assembly;

11 high-strength steel rod.

### SPECIFIC EMBODIMENTS

The technical solution provided by the present invention will be further described below in conjunction with specific embodiments and accompanying drawings. The various advantages and features of the present invention will become apparent to one skilled in the art by reading the following description.

It should be noted that the embodiments of the present invention have better practicability and are not any form of limitation to the present invention. The technical features or combinations of technical features described in the embodiments of the present invention should not be considered isolated, and they can be combined with each other to achieve better technical effects. It will be apparent to those skilled in the art of embodiments of the present invention that the scope of the preferred implementation of the present invention may also include other implementations.

Techniques, methods, and devices known to those of ordinary skill in the relevant art may not be discussed in detail, but should, where appropriate, be regarded as part of the authorized specification. In all examples shown and discussed herein, any specific values should be construed as merely exemplary and not as limiting. Accordingly, other examples of exemplary embodiments may have different values.

The accompanying drawings of the present invention are in a very simplified form and use inaccurate scales, and are only for the purpose of convenience and clarity to assist in describing embodiments of the present invention, and are not intended to limit the applicable restrictions. Any structural modification, change of proportional relationship, or adjustment of size should fall within the scope of the technical content disclosed in this application without affecting the effects and objectives that can be achieved in this application. And the same reference numerals appearing in the drawings of the present invention represent the same features or components, which may be applied to different embodiments.

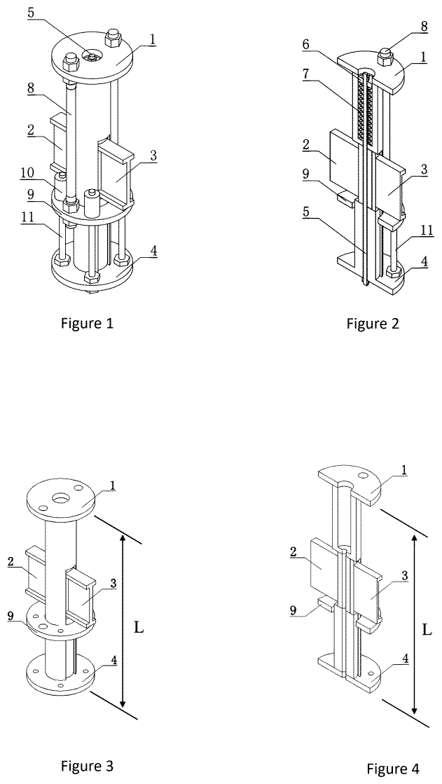

The present invention proposes a self-resetting shear-resistant device with low prestressing requirements and force transmission through a unidirectional clamp, a structure of which is shown in FIG. 1 and FIG. 2, comprising: a replaceable energy dissipation system, a self-resetting prestressing system, and a support and transmission mechanism for installing the energy dissipation system and the self-resetting prestressing system, wherein the energy dissipation system, the self-resetting prestressing system and the support and transmission mechanism are integrally formed and connected to import energy through the support and transmission mechanism; in terms of functional relationship, when undergoing shear deformations (loading), the energy dissipation system in the self-resetting shear-resistant device is subjected to tensile yield deformations, and meanwhile, a prestressing screw in the self-resetting prestressing system is subjected to tensile elastic deformations and a disc spring assembly is subjected to compressive elastic deformations, with resetting completed by restoring forces produced by deformations of the self-resetting prestressing system during shear deformations (loading).

As shown in FIG. 3 and FIG. 4, the support and transmission mechanism comprises an upper end connecting component 1, an intermediate connecting component 9, and a lower end connecting component 4, forming a support for installing the self-resetting prestressing system and the energy dissipation system; two end surfaces of the upper end connecting component 1 and the lower end connecting component 4 determine an initial length L of a shear energy dissipation device before separation in a longitudinal direction;
further comprising a left end connecting component 2 and a right end connecting component 3, which form a movable nested structure; the movable nested structure is located between the upper end connecting component 1 and the intermediate connecting component 9, and extends through a wing portion for inputting external shear dislocations and importing energy;
a movable shaft body of the movable nested structure is arranged in a cavity of the upper end connecting component 1 with two wings extending from a side wall of the cavity, upper ends and lower ends of the movable shaft body are in rigid contact with the upper end connecting component 1 and the lower end connecting component 4 respectively, and the movable nested structure slides against each other in an axial direction after inputting the shear dislocations to push the upper end connecting component 1 and the lower end connecting component 4 to be separated.

Specifically, in the support and the transmission mechanism:

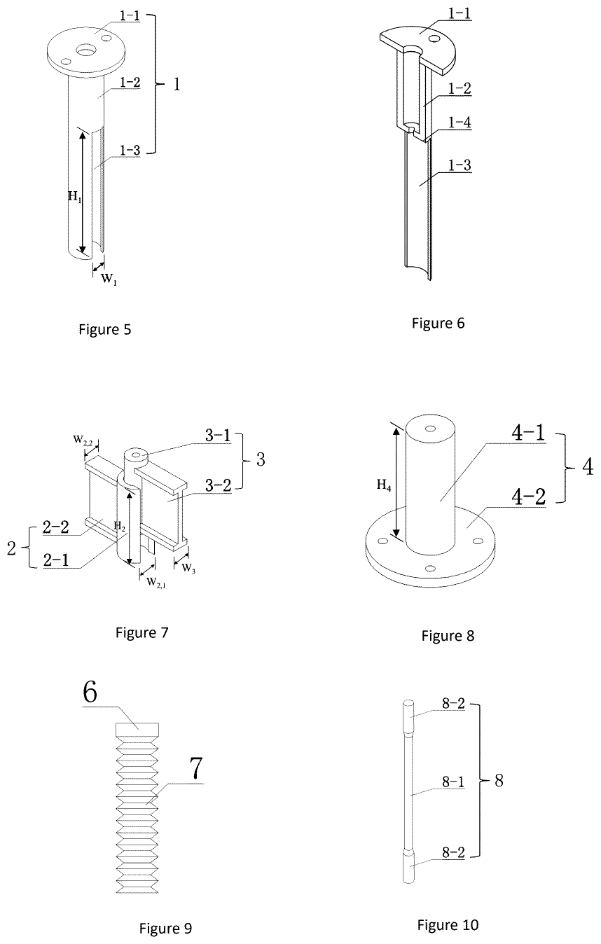

As shown in FIG. 5 and FIG. 6, a main body of the upper end connecting component 1 comprises a hollow cylinder, which is divided into two open cavities by an intermediate plate 1-4, with a top opening of the upper cavity 1-2 fixed with a top connecting plate 1-1, and a bottom opening of the lower cavity 1-3 symmetrically grooved on side walls along a center axis of the cavity.

As shown in FIG. 8, the lower end connecting component 4 comprises a cylindrical rod member 4-1, and a bottom connecting plate 4-2 fixed to a bottom of the cylindrical rod member 4-1.

Further, as an embodiment, the intermediate connecting component 9 is provided with an opening in a center for the lower cavity 1-3 of the upper end connecting component 1 to pass through.

As shown in FIG. 7, the movable nested structure comprises the left end connecting component 2, the right end connecting component 3, with the right end connecting component 3 being inserted into the left end connecting component 2:
the left end connecting component 2 comprises a first cylinder 2-1 with slotted side walls and a first wing 2-2, the first wing 2-2 being fixed to an outer wall of the first cylinder 2-1, the first cylinder 2-1 being provided with slots in the side walls;
the right end connecting component 3 comprises a second cylinder 3-1 and a second wing 3-2, the second wing 3-2 being fixed to an outer wall of the second cylinder 3-1; the first cylinder 2-1 and second cylinder 3-1 are of a same height;
the second cylinder 3-1 is placed inside the first cylinder 2-1 to form the movable shaft body of the movable nested structure, and the second wing 3-2 extends out from a groove in the side wall of the first cylinder 2-1 to form a pair of wings of the movable nested structure with the first wing 2-2 on the other side of the movable shaft body, the second wing 3-2 protrudes from the slotted side walls of the first cylinder 2-1 to form a pair of wings of the movable nested structure together with the first wing 2-2 on an other side of the movable shaft body;
conversely, the left end connecting component and right end connecting component are interchangeable in position.

Further, in an axial direction, in a lengthwise direction, the movable nested structure is placed in the lower cavity 1-3 of the upper end connecting component 1, with the first wing 2-2 and the second wing 3-2 protruding from the slots on each side of the lower cavity 1-3 for connecting to an outside, respectively; a top of the movable shaft body of the movable nested structure is in rigid contact with the intermediate plate 1-4 of the upper end connecting component 1, and the bottom of the movable shaft body is placed on the top of and in rigid contact with the cylindrical rod member 4-1 of the lower end connecting component 4; the movable shaft, a cylindrical rod member 4-1 is stacked up and down and inserted and confined within the lower cavity 1-3.

Under a condition of external energy input, the movable nested structures slide axially against each other for relative displacement of the upper end connecting component 1 and the lower end connecting component 4.

Further, a width W_{2,2} of the first wing 2-2 is required to be less than a slotted width W₁ of the lower cavity 1-3 of the upper end connecting component 1, the width W3 of the second wing 3-2 is required to be less than both the slotted width W_{2,1} of the first cylinder 2-1 of the left end connecting component 2 and the slotted width W₁ of the lower cavity 1-3 of the upper end connecting component 1 to ensure that the left end connecting component 2 and the right end connecting component 3 can be staggered with each other inside the lower cavity 1-3.

Further, a sum of a height H₄ of the cylindrical rod member (4-1) and a height H₂ of the movable shaft body is required to be slightly greater than a height H₁ of the lower cavity (1-3) of the upper end connecting component, and twice the height H₂ of the movable shaft body is required to be less than the height H₁ of the lower cavity (1-3), satisfying the following relationship: H₄+H₂≥H₁>2H₂.

The energy dissipation system comprises more than two energy dissipation steel rods 8;
upper and lower ends of the energy dissipation steel rods 8 are fixed to the top connecting plate 1-1 of the upper end connecting component 1, and the intermediate connecting component 9, respectively.

During use, the energy dissipation steel rods 8 are consumables and can be replaced. Specifically, as shown in FIG. 10, the energy dissipation steel rods 8 are divided into three segments, the middle portion being a core energy dissipation segment 8-1, and the upper and lower portions being connecting segments 8-2, with the core energy dissipation segment 8-1 yielding and dissipating energy in tension, and the connecting segments 8-2 having a larger diameter to ensure that they do not yield during a loading process.

Furthermore, as an embodiment, the connecting segments 8-2 of the energy dissipation steel rods 8 are engraved with threads, and top and bottom ends of the energy-consuming steel rod 8 can be fixed to the top connecting plate 1-1 of the upper end connecting component, and to the intermediate connecting component 9 respectively by nuts.

The self-resetting prestressing system comprises a prestressing system and a self-resetting system installed on the support and transmission mechanism:
wherein, as shown in FIG. 1 and FIG. 9, the prestressing system comprises a prestressing screw 5, a disc spring baffle 6 and a disc spring assembly 7, the disc spring baffle 6 being provided at the top of the disc spring assembly 7; the disc spring assembly 7 comprises a plurality of disc springs connected in parallel, the disc spring assembly 7 and disc spring baffle 6 being set together in the upper cavity 1-2 of the upper end connecting component 1; the top connecting plate 1-1 of the upper end connecting component 1, the second cylinder 3-1 of the right end connecting component 3, the cylindrical rod member 4-1 of the lower end connecting component 4 and the bottom connecting plate 4-2 of the lower connecting component 4 are provided with through-holes in the center; the upper end of the prestressing screw 5 is fixed to the disc spring baffle 6, passes through the disc spring assembly 7 and the through-holes of each connecting component in sequence, and is then fixed to the bottom connecting plate 4-2;

Further, as an embodiment, the prestressing screw 5 can be fixed to the top disc spring baffle 6 and the bottom connecting plate 4-2 of the lower end connecting component 4 by bolts respectively;
wherein the self-resetting system comprises a self-locking clamp 10 and a high-strength steel rod 11; the self-locking clamp 10 is fixed to the intermediate connecting component 9, and the high-strength steel rod 11 is set between the intermediate connecting component 9 and the lower end connecting component 4; the upper end of the high-strength steel rod 11 is connected to the self-locking clamp 10 and the lower end of the high-strength steel rod 11 is fixed to the bottom connecting plate 4-2 of the lower end connecting component 4, forming a unidirectional force transmitting element.

Furthermore, as an embodiment, the self-locking clamp 10 can be fixed on the intermediate connecting component 9; the high-strength steel rod 11 can be fixed to the bottom connecting plate 4-2 of the lower end connecting component 4 through the nuts.

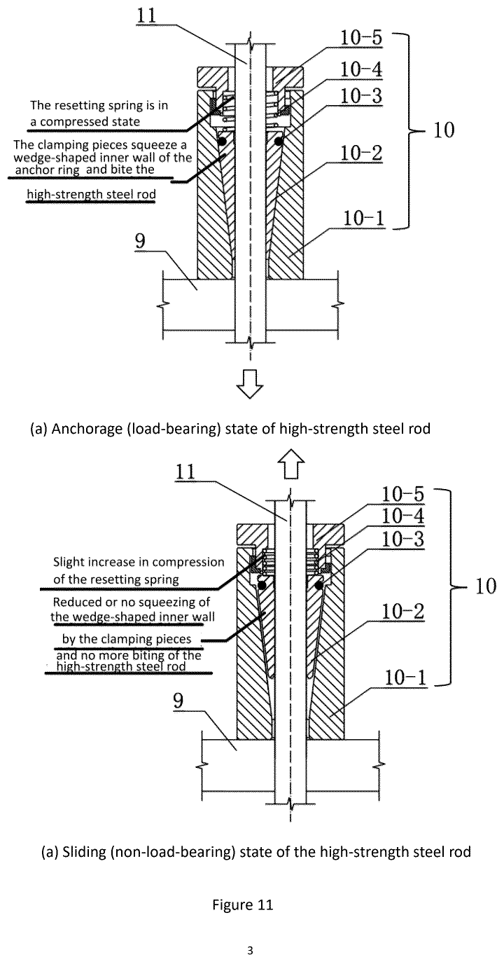

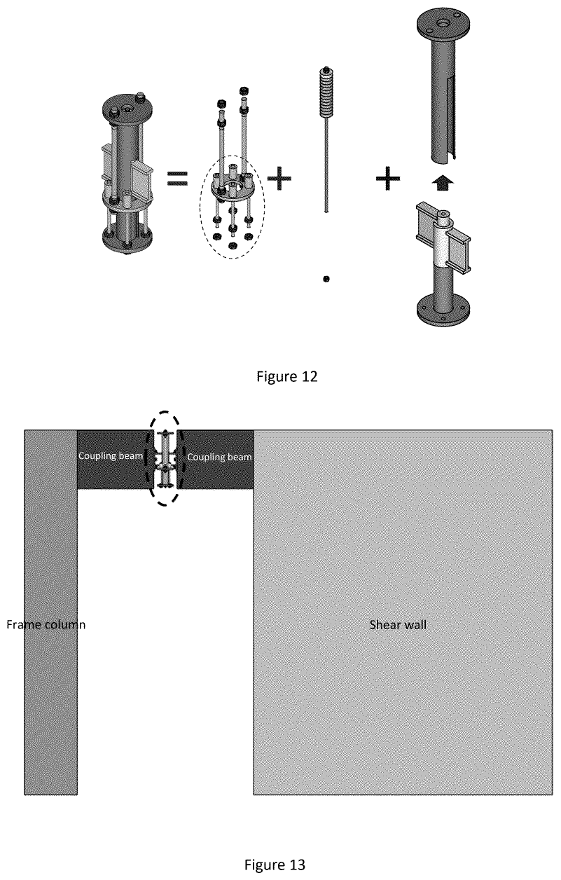

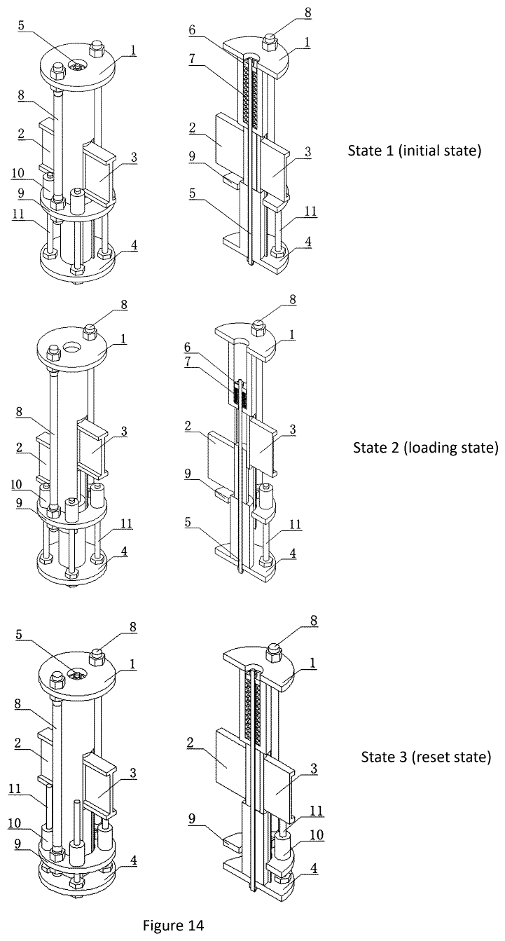

Specifically, as shown in FIG. 11, in an embodiment, the self-locking clamp 10 in the self-resetting system comprises an anchor ring 10-1, clamping pieces 10-2, an O-shaped rubber ring 10-3, a resetting spring 10-4, and a gland assembly 10-5, wherein:
the clamping pieces 10-2 are multiple pieces, built into the anchor ring 10-1, enclosing an outer part of the high-strength steel rod 11, with a groove reserved at ends of the clamping pieces and provided with the O-shaped rubber ring 10-3, so to enable the clamping pieces to work stably in a gap cavity between the anchor ring 10-1 and the high-strength steel rod 11;
the resetting spring 10-4 is provided in an upper part of the clamping pieces 10-2, and the high-strength steel rod 11 passes through the resetting spring 10-4;
the gland assembly 10-5 is set on the upper part of the anchor ring 10-1 to hold against the resetting spring 10-4, in order for axial stabilization in operation;
the self-locking clamp 10 supports a force in tension by means of occlusion between a plurality of clamping pieces 10-2 and the high-strength steel rod 11, while in compression the clamping pieces 10-2 and the high-strength steel rod 11 are loosened from each other, generating a relative sliding with the high-strength steel rod 11 without bearing force.

The above design allows the self-locking clamp 10 to bear force when under tension by engaging multiple enclosed clamping pieces 10-2 with the high-strength steel rod 11; and when under compression, the clamping pieces 10-2 and the high-strength steel rod 11 are loosened, causing relative sliding with the high-strength steel rod 11 without bearing force.

In an embodiment, a structure and working principles of the self-locking clamp are shown in FIG. 11. In an energy dissipation state, the present device is in a anchorage (load-bearing) state of the high-strength steel rod shown in FIG. 11(a): the clamping pieces 10-2 will bite the high-strength steel rod 11 and bear loads, thereby stretching the energy dissipation steel rods 8 to dissipate energy; During a resetting state, as shown in FIG. 11(b), the present device is in a sliding (non-load-bearing) state of the high-strength steel rod: the clamping pieces 10-2 no longer bite the high-strength steel rod, the resetting spring 10-4 is compressed, the high-strength steel rod 11 and the clamping pieces 10-2 are not load-bearing, and the self-locking clamp 10 and the intermediate connecting component 9 slide toward the lower end connecting component 4 to avoid compression of the energy dissipation steel rods 8 that is in a stretched state during the energy dissipation state. In an embodiment, in order to further demonstrate a structural design of the self-resetting shear-resistant device with low prestressing requirements and force transmission through a unidirectional clamp of the present invention, a deconstruction schematic diagram as shown in FIG. 13 is provided.

In order to further demonstrate a design principle of the self-resetting shear-resistant device with low prestressing requirements and force transmission through a unidirectional clamp of the present invention, an instance is provided:
Energy dissipation shear-resistant devices can currently be applied in many scenarios, such as installation between shear wall-columns, between different spans of frames, and at inflection points in a mid-span of coupling beams. This type of device yields before a main structure based on ductility requirements of a seismic design, concentrating deformation and energy dissipation in this type of device at the same time, and playing a role of protecting the main structure. By way of example and not limitation, as shown in FIG. 3, an application scenario is that the present device is installed between a shear wall and a column, and specifically, a coupling beam between the shear wall and the column is respectively connected and installed with the left end connecting component 2 and the right end connecting component 3 of the present device on both sides. In this way, a mechanism of operation of the present device is as follows (three states shown in FIG. 13):
1) In an initial stationary state, at this time, a layout structure of the upper end connecting component 1, the lower end connecting component 4, the left end connecting component 2 and the right end connecting component 3 is shown in FIGS. 3 and 4, and the top of the movable shaft body of the movable nested structure comprising the left end connecting component 2 and the right end connecting component 3 is pressed against the intermediate plate 1-4 of the upper end connecting component 1; the disc spring assembly 7 being in a slightly compressed state in an initial state due to the prestressing; the energy dissipation steel rods 8 being stationary on the present device
2) When an earthquake disaster occurs and external force is input from a certain direction, when the shear deformations is required, the left end connecting component 2 and the right end connecting component 3 of the present device are misaligned with each other by the external force, pushing the upper end connecting component 1 and the lower end connecting component 4 to undergo an axial relative displacement. In this case:
the disc spring assembly 7 in the prestressing system is continuously compressed and stores energy in the upper cavity 1-2;
the high-strength steel rod 11 in the self-resetting system synchronously occludes (a clamped state) with the self-locking clamp 10 to perform a self-locking function;
the energy dissipation steel rods 8 outside the upper cavity 1-2 are synchronized to enter an energy dissipation mechanism, which elongates and deforms the energy dissipation materials one by one, and consumes energy by tensile yielding;
during this period, a distance between the intermediate connecting component 9 and the lower end connecting component 4 remains constant, and at this time, the distance between the upper end connecting component 1 and the intermediate connecting component 9 increases, which determines that a total length of the present device L increases simultaneously.
3) In a critical state, when the external energy, the external force, stops being input, or when energy stored in the disc spring assembly 7 is greater than the external force, the misalignment displacements of the left end connecting component 2 and right end connecting component 3 show a tendency to decrease. In this case:
the prestressing system consisting of the prestressing screw 5 and the disc spring assembly 7 in series will undergo a reset action due to compression;
along with a resetting process of the prestressing system, the high-strength steel rod 11 and the self-locking clamp 10 in the self-resetting system play an unlocking function and slide relatively, and the high-strength steel rod 11 extends out of the self-locking clamp 10; since frictional resistance is avoided during sliding reset, a small amount of prestressing can achieve a resetting goal.

When fully reset, in terms of product appearance, the left end connecting component 2, the right end connecting component 3 and the disc spring assembly 7 is are restored to the initial state, the distance between the upper end connecting component 1 and the lower end connecting component 4 returns to is restored to the initial state, and the distance between the intermediate connecting component 9 and the lower end connecting component 4 is synchronously reduced.

When used, the self-resetting shear-resistant device with low prestressing requirements and force transmission through a unidirectional clamp has three states: state 1 (initial state), state 2 (loading state), and state 3 (reset state). Accordingly, the resetting spring 10-4 of the self-locking clamp 10 is also in various degrees of compression: maintaining occlusion (presence of force transmission) to keep and guarantee stiffness; and adapting to a transition from state one to state two, the high-strength steel rod 11 follow the lower end connecting component 4 (displacement in a direction away from the upper end connecting component 1).

Specifically:
State 1 (initial state): The resetting spring 10-4 is in a compressed state, exerting pressure on the clamping pieces 10-2; at this time, the clamping pieces squeeze a wedge-shaped inner wall of the anchor ring 10-1 and bite the high-strength steel rod 11.
State 2 (loading state): The resetting spring 10-4 is in a compressed state, exerting a same degree of pressure on the clamping pieces 10-2; the high-strength steel rod 11 tends to move downward, and a friction between the clamping pieces and the high-strength steel rod 11 makes the clamping pieces squeeze the wedge-shaped inner wall of the anchor ring 10-1 more severely than in state 1, causing the clamping pieces to continuously bite the high-strength steel rod 11.
State 3 (reset state): The resetting spring 10-4 is still in a compressed state (a degree of compression is slightly increased); the high-strength steel rod 11 tends to move upward. At this time, the friction between the clamping pieces and the high-strength steel rod 11 reduces or eliminates squeezing generated by the clamping pieces on the wedge-shaped inner wall of the anchor ring 10-1 compared to state 1, causing the clamping pieces to no longer bite the high-strength steel rod 11, as shown in FIG. 11.

A function of the resetting spring 10-4 is to prevent the high-strength steel rod from moving upward and driving the clamping pieces to move upward together.

The present device comprises only components widely used in an engineering industry, with low cost, reliable performance, no need for component finishing, and strong deformation capacity, which can be widely used in the seismic design of new buildings and existing buildings.

The foregoing description is to be considered merely as better specific implementations of the embodiments and not in limitation thereof. Any equivalent substitutions or changes made by those skilled in the art within the technical scope disclosed herein based on the technical solution and concept of this present disclosure shall be covered by the scope of the present disclosure.

1. A self-resetting shear-resistant device with low prestressing requirements and force transmission through a unidirectional clamp, comprising: a replaceable energy dissipation system, a self-resetting prestressing system, and a support and transmission mechanism for installing the energy dissipation system and the self-resetting prestressing system, wherein the energy dissipation system, the self-resetting prestressing system and the support and transmission mechanism are integrally formed and connected to import energy through the support and transmission mechanism;
wherein when undergoing shear deformations, the energy dissipation system in the self-resetting shear-resistant device is subjected to tensile yield deformations, and meanwhile, a prestressing screw in the self-resetting prestressing system is subjected to tensile elastic deformations and a disc spring assembly is subjected to compressive elastic deformations, with resetting completed by restoring forces produced by deformations of the self-resetting prestressing system during shear deformations;
wherein the support and transmission mechanism comprises an upper end connecting component (1), an intermediate connecting component (9), and a lower end connecting component (4), forming a support for installing the self-resetting prestressing system and the energy dissipation system; two end surfaces of the upper end connecting component (1) and the lower end connecting component (4) determine an initial length L of a shear energy dissipation device before separation in a longitudinal direction;
further comprising a left end connecting component (2) and a right end connecting component (3), which form a movable nested structure; the movable nested structure is located between the upper end connecting component (1) and the intermediate connecting component (9), and extends through a wing portion for inputting external shear dislocations and importing energy;
a movable shaft body of the movable nested structure is arranged in a cavity of the upper end connecting component (1) with two wings extending from a side wall of the cavity, upper ends and lower ends of the movable shaft body are in rigid contact with the upper end connecting component (1) and the lower end connecting component (4) respectively, and the movable nested structure slides against each other in an axial direction after inputting the shear dislocations to push the upper end connecting component (1) and the lower end connecting component (4) to be separated.

2. (canceled)

3. The self-resetting shear-resistant device with low prestressing requirements and force transmission through a unidirectional clamp according to claim 2, wherein:
a main body of the upper end connecting component (1) comprises a hollow cylinder, which is divided into two open cavities by an intermediate plate (1-4), with a top opening of the upper cavity (1-2) fixed with a top connecting plate (1-1), and a bottom opening of the lower cavity (1-3) symmetrically grooved on side walls along a center axis of the cavity;
the lower end connecting component (4) comprises a cylindrical rod member (4-1), and a bottom connecting plate (4-2) fixed to a bottom of the cylindrical rod member (4-1);
the intermediate connecting component (9) is provided with an opening in a center for the lower cavity (1-3) of the upper end connecting component (1) to pass through;
the movable nested structure comprises the left end connecting component (2), the right end connecting component (3), with the right end connecting component (3) being inserted into the left end connecting component (2);
the left end connecting component (2) comprises a first cylinder (2-1) with slotted side walls and a first wing (2-2), the first wing (2-2) being fixed to an outer wall of the first cylinder (2-1), the first cylinder (2-1) being provided with slots in the side walls;
the right end connecting component (3) comprises a second cylinder (3-1) and a second wing (3-2), the second wing (3-2) being fixed to an outer wall of the second cylinder (3-1);
the first cylinder (2-1) and second cylinder (3-1) are of a same height;
the second cylinder (3-1) is placed inside the first cylinder (2-1) to form the movable shaft body of the movable nested structure, and the second wing (3-2) extends out from a groove in the side wall of the first cylinder (2-1) to form a pair of wings of the movable nested structure with the first wing (2-2) on the other side of the movable shaft body, the second wing (3-2) protrudes from the slotted side walls of the first cylinder (2-1) to form a pair of wings of the movable nested structure together with the first wing (2-2) on an other side of the movable shaft body;
conversely, the left end connecting component and right end connecting component are interchangeable in position.

4. The self-resetting shear-resistant device with low prestressing requirements and force transmission through a unidirectional clamp according to claim 3, wherein in an axial direction, in a lengthwise direction, the movable nested structure is placed in the lower cavity (1-3) of the upper end connecting component (1), with the first wing (2-2) and the second wing (3-2) protruding from the slots on each side of the lower cavity (1-3) for connecting to an outside, respectively; a top of the movable shaft body of the movable nested structure is in rigid contact with the intermediate plate (1-4) of the upper end connecting component (1), and the bottom of the movable shaft body is placed on the top of and in rigid contact with the cylindrical rod member (4-1) of the lower end connecting component (4); the movable shaft, a cylindrical rod member (4-1) is stacked up and down and inserted and confined within the lower cavity (1-3); under a condition of external energy input, the movable nested structures slide axially against each other for relative displacement of the upper end connecting component (1) and the lower end connecting component (4).

5. The self-resetting shear-resistant device with low prestressing requirements and force transmission through a unidirectional clamp according to claim 3, wherein a width W_{2,2} of the first wing (2-2) is required to be less than a slotted width W₁ of the lower cavity (1-3) of the upper end connecting component (1), the width W₃ of the second wing (3-2) is required to be less than both the slotted width W_{2,1} of the first cylinder (2-1) of the left end connecting component (2) and the slotted width W₁ of the lower cavity (1-3) of the upper end connecting component (1) to ensure that the left end connecting component (2) and the right end connecting component (3) can be staggered with each other inside the lower cavity (1-3).

6. The self-resetting shear-resistant device with low prestressing requirements and force transmission through a unidirectional clamp according to claim 3, wherein a sum of a height H₄ of the cylindrical rod member (4-1) and a height H₂ of the movable shaft body is required to be slightly greater than a height H₁ of the lower cavity (1-3) of the upper end connecting component, and twice the height H₂ of the movable shaft body is required to be less than the height H₁ of the lower cavity (1-3), satisfying the following relationship: H₄+H₂≥H₁>2H₂.

7. The self-resetting shear-resistant device with low prestressing requirements and force transmission through a unidirectional clamp according to claim 3, wherein the energy dissipation system comprises more than two energy dissipation steel rods (8);
upper and lower ends of the energy dissipation steel rods (8) are fixed to the top connecting plate (1-1) of the upper end connecting component (1), and the intermediate connecting component (9), respectively.

8. The self-resetting shear-resistant device with low prestressing requirements and force transmission through a unidirectional clamp according to claim 7, wherein the self-resetting prestressing system comprises a prestressing system and a self-resetting system:
wherein the prestressing system comprises a prestressing screw (5), a disc spring baffle (6) and a disc spring assembly (7), the disc spring baffle (6) being provided at the top of the disc spring assembly (7); the disc spring assembly (7) comprises a plurality of disc springs connected in parallel, the disc spring assembly (7) and disc spring baffle (6) being set together in the upper cavity (1-2) of the upper end connecting component (1); the top connecting plate (1-1) of the upper end connecting component (1), the second cylinder (3-1) of the right end connecting component (3), the cylindrical rod member (4-1) of the lower end connecting component (4) and the bottom connecting plate (4-2) of the lower connecting component (4) are provided with through-holes in the center; the upper end of the prestressing screw (5) is fixed to the disc spring baffle (6), passes through the disc spring assembly (7) and the through-holes of each connecting component in sequence, and is then fixed to the bottom connecting plate (4-2);
wherein the self-resetting system comprises a self-locking clamp (10) and a high-strength steel rod (11); the self-locking clamp (10) is fixed to the intermediate connecting component (9), and the high-strength steel rod (11) is set between the intermediate connecting component (9) and the lower end connecting component (4); the upper end of the high-strength steel rod (11) is connected to the self-locking clamp (10) and the lower end of the high-strength steel rod (11) is fixed to the bottom connecting plate (4-2) of the lower end connecting component (4), forming a unidirectional force transmitting element.

9. The self-resetting shear-resistant device with low prestressing requirements and force transmission through a unidirectional clamp according to claim 8, wherein the self-locking clamp (10) in the self-resetting system comprises an anchor ring (10-1), clamping pieces (10-2), an O-shaped rubber ring (10-3), a resetting spring (10-4), and a gland assembly (10-5), wherein:
the clamping pieces (10-2) are multiple pieces, built into the anchor ring (10-1), enclosing an outer part of the high-strength steel rod (11), with a groove reserved at an end of the clamping pieces and provided with the O-shaped rubber ring (10-3), so to enable the clamping pieces to work stably in a gap cavity between the anchor ring (10-1) and the high-strength steel rod (11);
the resetting spring (10-4) is provided in an upper part of the clamping pieces (10-2), and the high-strength steel rod (11) passes through the resetting spring (10-4);
the gland assembly (10-5) is set on the upper part of the anchor ring (10-1) to hold against the resetting spring (10-4), in order for axial stabilization in operation;
the self-locking clamp (10) supports a force in tension by means of occlusion between a plurality of clamping pieces (10-2) and the high-strength steel rod (11), while in compression the clamping pieces (10-2) and the high-strength steel rod (11) are loosened from each other, generating a relative sliding with the high-strength steel rod (11) without bearing force.
